(19) United States
(12) Patent Application Publication
(10) Pub. No.: US 2021/0381079 A1
(43) Pub. Date: Dec. 9, 2021

(54) LEACHING AIDS AND METHODS OF USING LEACHING AIDS

(71) Applicant: BASF SE, LudwigshafenamRhein (DE)

(72) Inventor: Jack Bender, Tucson, AZ (US)

(21) Appl. No.: 17/282,487

(22) PCT Filed: Oct. 10, 2019
(86) PCT No.: PCT/US19/55504

§ 371 Date: Apr. 2, 2021

Related U.S. Application Data
(60) Provisional application No. 62/744,775, filed on Oct. 12, 2018.

(51) Int. Cl. C22B 3/16; C22B 11/00

(52) U.S. Cl. CPC C22B 3/1625; C22B 11/04

(57) ABSTRACT

Disclosed are leaching aids and methods of using the leaching aids. The leaching aids can include one or a combination of compounds. The methods of using the leaching aids can include a process of recovering metal from ore, for example, a process involving leaching, concentration and purification unit operations.

### FIELD

Disclosed herein are leaching aids and methods of using leaching aids to recover metals from a leaching solution. In some embodiments, the leaching aids can include one or a combination of components. The methods of using the leaching aids can include a process of recovering a metal (e.g., gold) from an ore, for example, a process involving leaching, concentration and purification unit operations.

### BACKGROUND

Gold occurs mainly as a native metal, in alloys with silver or other metals or as tellurides. Gold is commonly associated with sulfides of iron, silver, arsenic, antimony and copper. Silver usually occurs as finely distributed metal in rocks having a hydrothermal origin, for example, as silver chloride, silver sulfide or tellurides and as complex sulfides with antimony and arsenic.

Leaching and absorption-desorption-regeneration (ADR) extraction can be used to recover gold from ore depending on the ore's grade and nature. Both processes result in waste streams containing dilute solutions having low levels of cyanide, metal cyanide complexes and, depending on the ore, other toxic metal species such as selenate or arsenate. During hydrometallurgical processes, gold can be extracted when the metal-containing material is leached, for example, by applying a lixiviant to a collection of ore. A common lixiviant used in the mining industry to leach gold is an alkaline cyanide. The leaching process can be a pile, tray or vat (i.e., carbon-in-pulp) leaching process.

Despite the leaching method, the intrinsic principles of leaching are the same. See C. K. Gupta, T. K. Mukherjee. Hydrometallurgy in Extraction Processes, vol. 1. First, the process must dissolve the ore minerals fast enough to enable commercial extraction; the process should be chemically inert to gangue minerals because when such minerals are attacked, an excessive volume of the lixiviant is used and the leach liquor becomes undesirably fouled with impurities. Second, the process must be inexpensive and readily scalable to large quantities. Third, if possible, the process should be regenerable following leaching. An underpinning characteristic of leaching is that regardless of the lixiviant used, it must be able to interact with the ore particles in a way that allows for transfer of the desired metal from the ore into a collected and then managed solution.

Low grade ores containing gold distributed in siliceous rock are commonly leached by piling the crushed ore on pads to a depth of several feet and then distributing an aqueous cyanide solution across the surface of the ore. As the cyanide solution trickles through the ore, the gold is leached from the ore as a soluble aurocyanide species. The gold bearing leach solution is collected at the bottom of the pile and pumped to a treatment facility for recovery of the gold. When the amount of gold in the leach solution drops to a certain level making it no longer economical to treat the ore, leaching is stopped and the metal-depleted ore is abandoned. At this time, the metal-depleted ore is saturated with the dilute aqueous cyanide solution containing various additional metal cyanide complexes as well as potentially other toxic metal species. The dilute solution must then be washed from the ore and treated to break down the various cyanide species and remove the remaining toxic metal species. If the metal-depleted ore is not washed, these cyanide species and toxic metal species will continue to leach from the ore over time, resulting in an environmental threat to wildlife and groundwater.

When an ore contains free gold metal together with gold associated with pyrite, the gold associated with pyrite cannot be recovered by direct cyanide leaching of the ore. The free gold can be recovered by grinding the ore and leaching it with cyanide and using activated carbon or an ion exchange polymer to recover the gold. However, for ore bodies containing pyrite, a typical process used to recover the pyrite in association with gold is by flotation and to use cyanide leaching for the free gold remaining in the ore. Subsequently, the pyrite is roasted to expose the associated gold and the roast is leached with cyanide to recover the gold. A flotation process concentrates the metal values as their sulfides from a sulfide ore into a concentrate that can be further treated by other processes such as smelting to recover the metals themselves.

In many locations where flotation plants are placed, availability of water for mineral processing is a serious issue. In such arid regions, the process water must be recycled. During certain stages, cyanide can be added as a depressant. However, it is desirable to thereafter remove the cyanide ion and anionic cyanide metal complexes from the process water before use in pyrite flotation. After such removal, the resultant purified water can then be returned to the flotation process.

ADR processes are used to treat higher grade ores or ores wherein the gold is locked in a matrix. In an ADR process, the ore is finely ground and positioned in a leaching vessel containing carbon and alkaline cyanide solution. During leaching, the gold is adsorbed by the carbon. The remaining slurry undergoes a series of solid/liquid separation operations before deposition in a tailings dam as thickened slurry. Water continues to separate over time from the tailings. The separated water contains low levels of cyanide and metal cyanide species. The water must be treated before returning to the leaching or flotation process or being discharged into the environment.

There remains a need for leaching reagents and methods of using the leaching reagents to recover gold and additional metals from ore. According to various embodiments, the leaching aids are compatible in all aspects of a process including leaching, ADR extraction, solvent extraction, ion exchange, solid phase extraction, smelting and/or electro winning.

### BRIEF SUMMARY

According to embodiments, disclosed herein is a solution comprising:

a lixiviant for extracting gold; and

one or more compound comprising formula (I):

R((AO)ₙB)ₘ((AO)ₙH)ₚ (I)
wherein each AO group is, independently, an alkyleneoxy group selected from ethyleneoxy (“EO”), 1,2-propyleneoxy (“PO”), 1,2-butyleneoxy, and styryleneoxy;
each n is independently an integer from 0 to 40;
m is an integer from 1 to the total number of OH hydrogens in the R group prior to alkoxylation;
p is an integer such that the sum of m plus p equals the number of OH hydrogens in the R group prior to alkoxylation;
Bis H;
R is a group selected from formula (II) to (VIII):

R₁C(CH₂O)₃ (II)

wherein R₁ is H, methyl, ethyl, or propyl;

C(CH₂O)₄ (III);

OC(CH₂O)₂ (IV);

N(CH₂CH₂O) (V)

(R₂)ₓN(CH₂CH₂O) (VI)

wherein R₂ is a C₁-C₄ alkyl, y is 1-3 and x+y=3;

O(CH₂)ᵣO (VII),

wherein r is 2 to 6; and

O(CH(CH₃)CH₂)O (VIII);

wherein the one or more compound is at a concentration of about 1 ppm to about 500 ppm of the solution, and

optionally wherein the solution further comprises gold.

Further disclosed herein is a solution, comprising:

a lixiviant for extracting gold; and

one or more compound having formula (IX):

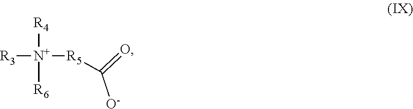

wherein R₃ is a C₁ to C₂₀ linear or branched alkyl group comprising zero or more substitutions with any of O, N, OH or

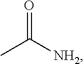

R₄ and R₆ are each, independently, H, a C₁ to C₁₀ linear or branched alkyl group or an alcohol group,
R₅ is a C₁ to C₁₀ linear or branched alkyl group; and

wherein the one or more compound is at a concentration of about 5 ppm to about 500 ppm,

wherein when the solution has a pH of less than 7.0, formula (IX) further comprises a counter ion to the O⁻ selected from a group consisting of H, a sulfate group and a sulfonate group, and

wherein the solution further comprises gold.

According to further embodiments, disclosed is a method of leaching gold from an ore, the method comprising contacting the ore comprising the gold with any solution as described above.

In yet further embodiments, disclosed is a method of recovering gold from an ore, comprising contacting the ore comprising the gold with any solution as described above to form a pregnant leaching solution; and recovering the gold from the pregnant leaching solution.

According to embodiments, disclosed is a solution comprising:

a lixiviant comprising an alkaline cyanide; and

a mixture of compounds formed by alkoxylation of trimethylolpropane (“TMP”), wherein each of the compounds comprise ethylene oxide (“EO”) units, the compounds having the general structure:

TMP-EO_{x,y,z}, where x, y and z are independently an integer from 0 to 7, with the proviso that x+y+z=0 to 21,

wherein the mixture is at a total concentration of about 1 ppm to about 100 ppm, and

wherein the solution comprises gold.

The above summary provides a basic understanding of the disclosure. This summary is not an extensive overview of all contemplated embodiments, and is not intended to identify all key or critical elements or to delineate the scope of any or all embodiments of the disclosure. Its sole purpose is to present one or more embodiments in a summary form as a prelude to the more detailed description that follows and the features described and particularly pointed out in the claims.

### DETAILED DESCRIPTION

Embodiments are described herein in the context of leaching aids for use in leaching solutions and methods of using the leaching aids. Those of ordinary skill in the art will recognize that the following description is illustrative only and is not intended to be in any way limiting. Other embodiments will readily suggest themselves to those of ordinary skill in the art having the benefit of this disclosure. Reference will now be made in detail to implementations of the example embodiments as illustrated in the accompanying drawings. The same reference indicators will be used to the extent possible throughout the drawings and the following description to refer to the same or like items.

### Definitions

Reference throughout the disclosure to terms such as “one embodiment,” “certain embodiments,” “one or more embodiments,” “various embodiments,” “an embodiment” and so forth mean that a particular feature, structure, material, or characteristic described in connection with the embodiment is included in at least one embodiment. Thus, such terms throughout the disclosure are not necessarily referring to the same embodiment. Furthermore, the particular features, structures, materials, or characteristics may be combined in any suitable manner in one or more embodiments.

As used herein, the singular forms “a,” “an,” and “the” include plural references unless the context clearly indicates otherwise. Thus, for example, reference to “a metal” includes a single metal as well as two or more different metals.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. In certain embodiments, the term “about” includes the recited number ±10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything higher than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

### Leaching Aids

According to one or more embodiments, the disclosure relates to leaching aids for leaching solutions, for example, to improve the rate of recovery and/or the total recovery of metals (e.g., gold) from ore. The leaching solutions containing the leaching aids are compatible with various purification and/or concentration processes including ADR extraction, solvent extraction, electrowinning, ion exchange and solid phase extraction.

The leaching aids can include, but are not limited to, one or any combination of the following classes of compounds:
Sulfonate-, sulfate-, or carboxylate-capped, alkoxylated compounds
Betaines
Alkyl- and alkyl ether sulfates
Sulfosuccinates, alkoxylates (e.g., alkoxylated polyols), sulfosuccinamides
Acetylenic diols
Amphoacetates/propionates

According to one or more embodiments, the leaching aid can be a compound of formula (I) as follows:

R((AO)ₙB)ₘ((AO)ₙH)ₚ (I)

where each AO group is, independently, an alkyleneoxy group selected from ethyleneoxy (“EO”), 1,2-propyleneoxy (“PO”), 1,2-butyleneoxy, and styryleneoxy; n is an integer from 0 to 40; m is an integer from 1 to the total number of OH hydrogens in the R group prior to alkoxylation; p is an integer such that the sum of m plus p equals the number of OH hydrogens in the R group prior to alkoxylation; B is H, SO₃Y, (CH₂)_{q}SO₃Y, CH₂CHOHCH₂SO₃Y, or CH₂CH(CH₃)OSO₃Y, wherein q is an integer from 2 to 4 and Y is a cation; R is a group selected from formula (II) to (VIII) as follows:

| | |
|---|---|
| R₁C(CH₂O)₃ | (II) where R₁ is H, methyl, ethyl, or propyl; |
| C(CH₂O)₄ | (III); |
| OC(CH₂O)₂ | (IV); |
| N(CH₂CH₂O)₃ | (V); |
| (R₂)ₓN(CH₂CH₂O)_{y} | (VI) where R₂ is a C₁-C₄ alkyl, y is 1-3 and |
| | x + y = 3; |
| O(CH₂)ᵣO | (VII), where r is 2 to 6; and |
| O(CH(CH₃)CH₂)O | (VIII). |

According to embodiments, n can be 2 to 30, or 2 to 20, or 2 to 10, B can be Hydrogen and R can have formula (II). For example, a leaching solution can include a leaching aid comprising a distribution of compounds (e.g., where n on average is 7) including the following structure, which leaching aid may be referred to herein as “TMP-7(EO)”:

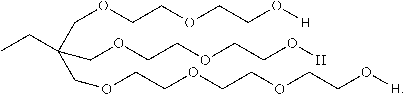

The TMP-7(EO) Leaching Aid may be present in the distribution of compounds at a concentration of about 0.5 wt % to about 10 wt %, or about 1 wt % to about 8 wt %, or about 2 wt % to about 5 wt %. The TMP-7(EO) Leaching Aid can be formed by an alkoxylation process of trimethylolpropane (“TMP”), where the process results in a mixture (i.e., a distribution) of trimethylolpropane compounds having a variety of ethylene oxide (“EO”) units including: TMP-EO_{x,y,z}, where x, y and z are independently an integer from 0 to 7, with the proviso that x+y+z=0 to 21. The resulting mixture of compounds includes one of the above TMP-7(EO) structure.

The alkoxylation may be catalyzed by strong bases added in the form of an alkali metal alcoholate, alkali metal hydroxide or alkaline earth metal hydroxide, in an amount of about 0.1% to about 1% by weight, based on the amount of the alkanol. See Gee et al., J. Chem. Soc., p. 1345 (1961); Wojtech, Makromol. Chem. 66, p. 180 (1966).

An acid catalysis of the addition reaction is also possible. In addition to Bronstedt acids, Lewis acids, such as, for example, AlCl₃ or BF₃ dietherate, BF₃, BF₃H₃PO₄, SbCl₄.2H₂O or hydrotalcite can also be used. See Plesch, The Chemistry of Cationic Polymerization, Pergamon Press, New York (1963).

According to embodiments, double metal cyanide (DMC) compounds may be used as catalysts. Suitable DMC catalysts are described in, for example, WO 99/16775 and DE-A-101 17 273, which are incorporated by reference herein in their entirety. Other suitable catalysts for the alkoxylation are double metal cyanide compounds as described in U.S. Pat. No. 6,753,402, which is incorporated by reference herein in its entirety. The catalysts may be crystalline or amorphous. The catalyst concentration used for the alkoxylation, based on the final quantity range, may be less than 2000 ppm (i.e. mg of catalyst per kg of product), or less than 1000 ppm, or less than 500 ppm, or less than 100 ppm, or less than 50 ppm or 35 ppm, or less than 25 ppm.

According to further embodiments, the leaching aid can include a mixture or distribution of compounds formed by an alkoxylation process of trimethylolpropane with seven equivalents of ethylene oxide as described above, wherein the resulting distribution of trimethylolpropane compounds having ethylene oxide units have the following general formula: TMP-EO_{x,y,z}, where x, y and z are independently an integer from 0 to 7, with the proviso that x+y+z=0 to 21. The mixture includes the following compound:

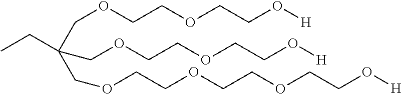

In embodiments, the leaching aid can have the formula (IX) as follows:

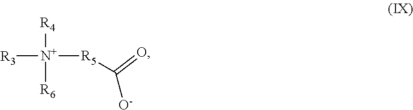

where R₃ is a C₁ to C₂₀ linear or branched alkyl group comprising zero or more substitutions with any of O, N, OH or

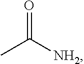

R₄ and R₆ are each, independently, H, a C₁ to C₁₀ linear or branched alkyl group or an alcohol group, and R₅ is a C₁ to C₁₀ linear or branched alkyl group. In the present disclosure, the term “alcohol group” means a C₁ to Cₓ linear or branched alkyl group having an —OH functionality where x is an integer, for example, x can be from 2 to 10 or from 2 to 20, or 2 to 30. According to embodiments, when the solution having the leaching aid is acidic, that is, has a pH of less than 7.0, formula (IX) further includes a counter ion to the O⁻. The counter ion may be selected from H, a sulfate group and a sulfonate group.

According embodiments, R₃ can be a C₁₀ linear or branched alkyl group and R₄, R₅ and R₆ can be, independently, a C₁ to C₃ alkyl group. For example, the leaching aid can have the following structure, which compound may be referred to herein as “MCI000”:

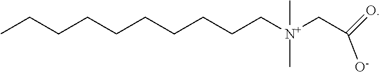 [SMILES: CCCCCCCCCC[N+](C)(C)CC(=O)[O-]]

According to embodiments, R₃ can include at least one

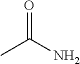

substitution, and R₄ and R₆ can be, independently, H or an alcohol group. For example, the leaching aid can have the following structure:

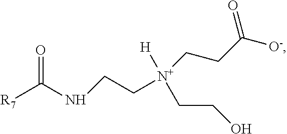

where R₇ is a C₁ to C₂₀ linear or branched alkyl group comprising zero or more substitutions with any of O, N, OH or

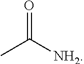

In accordance with various embodiments, the leaching aid can be an alkyl or alkyl ether sulfate having formula (X) or (XI) as follows:

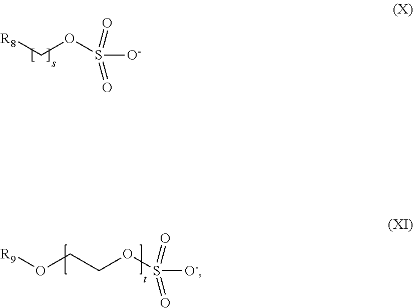

where s and t are each, independently, an integer from 0 to 10 and R₈ and R₉ are each, independently, a C₁ to C₂₀ linear or branched alkyl group.

In further embodiments, the leaching aid can have formula (XII) as follows:

R₁₀CH₂OC(O)C(SO₃⁻)CH₂C(O)OCH₂R₁₁Na⁺ (XII),

where R₁₀ and Rn are each, independently, a C₁ to C₆ linear or branched alkyl group.

In certain embodiments, the leaching aid can be an acetylenic diol having the following formula (XIII):

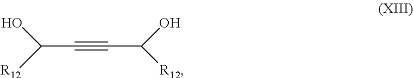

where R₁₂ is a C₁ to C₆ linear or branched alkyl group.

In embodiments, the leaching aid can be an amphoacetate having the following formula (XIV):

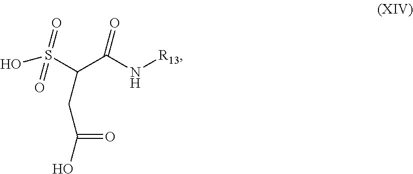

wherein R₁₃ is a C₂ to C₂₀ linear or branched alkyl group.

According to embodiments, a leaching solution can include a lixiviant and one or more leaching aid of formulas (I) and (IX)-(XIV) described above. For example, the leaching solution can include one or more of the TMP-7(EO) leaching aid and the MC1000 leaching aid.

The lixiviant can be any suitable aqueous solution for leaching metal values (e.g., gold) from ore. For example, in the case of gold-containing ores, the lixiviant for extracting gold can be selected from an alkaline cyanide solution (e.g. sodium cyanide), a bromine solution (e.g., containing bromide ion), a chlorine solution (e.g., containing chloride ion), an iodine solution (e.g., containing iodide ion), a thiosulfate solution or athiocyanide solution. According to embodiments, the lixiviant does not comprise sulfuric acid. The metal values can be in ionic form and/or in elementary form. In some embodiments, in addition to gold, the ore may contain at least one additional metal selected from copper, nickel, zinc, molybdenum, vanadium, uranium, and combinations thereof, any one or more of which may be present in the leaching solution. Leaching aids as described herein may also be added to wastewater that is used to clean metal-depleted ore after the bulk of the gold has been removed.

The lixiviant can be at a concentration of about 0.1 mg/L to about 100 g/L of the leaching solution containing the one or more leaching aid. According to embodiments, the lixiviant can be at a concentration of about 0.5 mg/L to about 75 g/L, or about 0.75 mg/L to about 50 g/L, or about 1.0 mg/L to about 25 g/L, or about 1.0 mg/L to about 10 g/L, or about 5 mg/L to about 1 g/L of the leaching solution containing the one or more leaching aid.

The one or more leaching aids used for improving the rate of recovery and/or total recovery of metals from ore, and which are compatible with numerous mining processes, can have various general characteristics. For example, the leaching aids can be anionic, cationic, nonionic or amphoteric surfactants or mixtures thereof. In certain embodiments, the leaching aids can be low-foaming surfactants.

Suitable cationic surfactants include tetraalkylammonium salts, imidazolinium salts, amine oxides or mixtures thereof. For example, C₈- to C₁₆-dialkyldimethylammonium salts, dialkoxydimethylammonium salts, imidazolinium salts having a long-chain alkyl radical, or mixtures thereof.

Suitable amphoteric surfactants include carboxylic acids, for example, ethylenically unsaturated carboxylic acids, and/or at least one ethylenically unsaturated monomer unit of the general formula R¹(R²)C═C(R³)R⁴, where R₁ to R₄, independently of one another, are —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above which are substituted by —NH₂, —OH or —COOH, a heteroatomic group having at least one positively charged group, a quaternized nitrogen atom or at least one amino group having a positive charge in the pH range from 2 to 11 or are —COOH or —COOR₅, where R₅ is a saturated or unsaturated, straight-chain or branched hydrocarbon radical having 1 to 12 carbon atoms. Examples of the abovementioned monomer units are diallylamine, methyldiallylamine, tetramethylammonium salts, acrylamidopropyl(trimethyl)ammonium salts (R¹, R² and R³═H, R⁴═C(O)NH(CH₂) 2N⁺(CH₃)₃X⁻), methacrylamidepropyl(trimethyl)ammonium salts (R¹ and R²═H, R³═CH₃, H, R₄═C(O)NH(CH₂) 2N⁺(CH₃)₃X⁻).

For example, amphoteric surfactants can include, as monomer units, derivatives of diallylamine, in particular, dimethyldiallylammonium salt and/or methacrylamidopropyl(trimethyl)ammonium salt, for example, in the form of the chloride, bromide, iodide, hydroxide, phosphate, sulfate, hydrogen sulfate, ethylsulfate, methylsulfate, mesylate, tosylate, formate or acetate, and/or in combination with ethyleneically unsaturated carboxylic acid monomer units.

Suitable non-ionic surfactants can include alcohol alkoxylates (e.g., alkoxylated polyols), alkylphenol alkoxylates, alkylpolyglucosides, N-alkylpolyglucosides, N-alkylglucamides, fatty acid alkoxylates, fatty acid polyglycol esters, fatty acid amine alkoxylates, fatty acid amide alkoxylates, fatty acid alkanolamide alkoxylates, N-alkoxypolyhydroxyfatty acid amides, N-aryloxypolyhydroxy-fatty acid amides, block copolymers of ethylene oxide, propylene oxide and/or butylene oxide, poly isobutene alkoxylates, polyisobutene/maleic anhydride derivatives, fatty acid glycerides, sorbitan esters, polyhydroxy-fatty acid derivatives, polyalkoxy-fatty acid derivatives, bisglycerides, or mixtures thereof.

Suitable anionic surfactants can include fatty alcohol sulfates, sulfated alkoxylated alcohols, alkanesulfonates, N-acyl sarcosinates, alkylbenzenesulfonates, olefin sulfonates and olefin disulfonates, alkyl ester sulfonates, sulfonated polycarboxylic acids, alkylglyceryl sulfonates, fatty acid glyceryl ester sulfonates, alkylphenol polyglycol ether sulfates, paraffinsulfonates, alkyl phosphates, acyl isothionates, acyl taurates, acylmethyl taurates, alkylsuccinic acids, alkenylsuccinic acids or the monoesters or monoamides thereof, alkylsulfosuccinic acids or the amides thereof, mono- and diesters of sulfosuccinic acids, sulfated alkylpolyglycosides, alkylpolyglycol carboxylates, hydroxyalkyl sarcosinates or mixtures thereof.

Additional characteristics of the leaching aids include high water solubility in the aqueous leaching solution to avoid extraction into the organic phase during ADR extraction. Other characteristics of the leaching aids include high critical micelle concentrations and stability at acidic and alkaline pH. The leaching aids can minimize foaming, and one or more surfactants can decrease the surface tension of the leaching solution. The leaching aids also should have no or minimal impact on any other process related to extraction of the metal (e.g. leaching, ADR extraction, solvent extraction, stripping and electrowinning including mixing, phase disengagement, extraction and strip kinetics, gold selectivity or build up in the organic over time). Suitable leaching aids furthermore, should be stable under the conditions of the leaching solution (e.g., alkaline cyanide) in an aqueous phase and should be biodegradable. Moreover, suitable leaching aids according to various embodiments can increase overall metal recovery (e.g., gold recovery) by at least 3%. In certain embodiments, the suitable leaching aids according to the disclosure can increase overall metal recovery by about 0.5% to about 20% or about 1% to about 20%, or about 2% to about 20%, or about 5% to about 20%, or about 0.5% to about 10% or about 2% to about 10% or about 5% to about 10%.

### Methods of Using Leaching Aids

According to embodiments, the one or more leaching aids as described herein can be added to any leaching solution for extracting gold and other metal values from an ore. The leaching aids can reduce the surface tension of the leaching solution and provide better wetting of the ore or ore particles during leaching. Additionally, this reduction in surface tension can prevent or reduce capillary action in the microscopic crevices of the ore.

In embodiments, the one or more leaching aids can be added to the leaching solution in a batch or continuous manner and the enhanced solution is contacted with the metal ore. The leaching solution containing the one or more leaching aids may be contacted with the metal ore, for example, during a pile leaching, tray leaching or vat leaching (i.e., carbon-in-pulp extraction) process. According to embodiments, contacting the metal ore with the leaching solution can include grinding the metal ore and slurrying the grinded ore with the leaching solution, for example, by using agitation.

The leaching solution containing the leaching aid(s) extracts a metal, for example, gold and/or additional metal values such as copper, iron, silver, nickel, zinc, molybdenum, vanadium, uranium, etc., from the ore. The lixiviant in the leaching solution can be any chemical as described herein, for example, an alkaline cyanide. During leaching or extraction, the leaching solution with the leaching aid(s) absorbs metals and forms a metal-rich solution.

The metal rich solution may be directed to a concentration process, for example, one or more unit operation such as an ADR extraction process, a solvent exchange process, a solid phase extraction process and/or an ion exchange process. A metal-rich concentrate from the concentration process can be isolated and/or collected and subsequently directed to a purification stage, for example, a unit operation such as a stripping, smelting, precipitation and/or electro winning process. During the purification stage, the metal is isolated and collected. As recognized by those of ordinary skill in the art, the product and waste streams from any of the unit operations described above may be recycled to appropriate process steps to increase metal recovery and to decrease cost.

The one or more leaching aids can be added to the leaching solution at a total concentration of about 1 parts per million (“ppm”) to about 2000 ppm, or about 1 ppm to about 500 ppm, or about 5 ppm to about 1000 ppm, or about 10 ppm to about 500 ppm, or about 20 ppm to about 100 ppm, or about 5 ppm to about 100 ppm, or about 10 ppm to about 50 ppm, or about 5 ppm to about 50 ppm, or about 10 ppm, or about 25 ppm, or about 50 ppm, or about 100 ppm, or about 250 ppm, or about 500 ppm, or about 1000 ppm, or about 2000 ppm in the leaching solution, or about 20 ppm to less than the critical micelle concentration of the leaching aid. Critical micelle values can be, for example, about 5 ppm to about 1000 ppm. For example, the leaching solution can include a leaching aid of formula (I) or (IX) at a total concentration of about 1 ppm to about 2000 ppm, or about 5 ppm to about 1000 ppm, or about 10 ppm to about 500 ppm, or about 20 ppm to about 100 ppm, or about 5 ppm to about 50 ppm, or about 5 ppm to about 100 ppm, or about 10 ppm to about 50 ppm, or about 10 ppm, or about 25 ppm, or about 50 ppm, or about 100 ppm, or about 250 ppm, or about 500 ppm, or about 1000 ppm, or about 2000 ppm in the leaching solution. According to certain embodiments, the leaching solution can include the TMP-7(EO) leaching aid or the MC1000 leaching aid at a total concentration of about 5 ppm to about 50 ppm, or about 5 ppm to about 100 ppm, or about 15 ppm to about 30 ppm, or about 10 ppm to about 100 ppm, or about 25 ppm to about 50 ppm, or about 25 ppm of the leaching solution.

As discussed above, the use of the ore leaching aids described herein can reduce the surface tension of the leaching solution and provide better wetting of the ore during leaching. Additionally, this reduction in surface tension can prevent or reduce capillary action in the microscopic crevices of the ore. When examining an ore, it can be observed that the path of a leaching solution must navigate through a labyrinth of channels and ore crevices wrought with ‘dead-ends’ (see FIG. 1). Robert W. Bartlett, Solution Mining Leaching and Fluid Recovery of Materials, p. 138. Once a leaching solution flows into a crevice and reacts with the surface of the ore, the now spent solution containing the desired metal is retained in the crevice due to capillary action. This results in no further leaching of the ore in that crevice. To aid in the leaching solution's flow through the channels and to achieve extraction of the valuable metal from ore crevices, a decrease in surface tension of the leaching solution can allow for a less hindered path for the extracted metal to pass.

The addition of surface active agents as leaching aids to the leaching solution can liberate the metal-containing solution from the crevices allowing fresh solution to penetrate into the crevices. For example, the capillary action can be reduced to about 80%, or about 70% or about 60% less than that of water alone through the addition of one or more of the leaching aids. This decrease in capillary action liberates the leaching solution from the crevice, which ultimately increases the rate of recovery and/or the total recovery of metal from the ore.

According to one or more embodiments, the leaching aids may reduce the surface tension of a leaching solution containing the leaching aid and a lixiviant to achieve a surface tension of about 71×10⁻³ N/m to about 30×10⁻³ N/m.

The leaching aids according to one or more embodiments herein, are compatible with several processes and process conditions, including, but not limited to, agglomeration, leaching, ADR extraction, solvent extraction, solid phase extraction, ion exchange, smelting, precipitation, stripping and electrowinning. The one or more leaching aids can have no or a limited impact on other processes, such that they are compatible with downstream processes after the one or more leaching aids have been used to recover the metal during leaching.

For example, solvent extraction is a carefully orchestrated balance of various metal and acid concentrations. The delicate chemical balance that is inherent to all solvent extraction operations can be negatively affected by the slightest interloper. For example, in a gold extraction process, all of the processes are interconnected and form a symbiotic relationship. Because of this relationship it is possible that if an additive is meant to amplify one part of the process (e.g., gold leaching) it could easily disrupt another segment (e.g., gold extraction) due to incompatible chemistry. Issues such as these can include: the formation of emulsions, entrainment, introduction of impurities into the tankhouse, manipulation of extraction and/or strip kinetics, degradation or staining of the reagent, or nullification of a particular step of the process. According to various embodiments, the leaching aids are compatible with leaching, extraction, stripping and electrowinning operations and do not result in the above-mentioned issues.

In another example, Adsorption-Desorption-Regeneration (ADR) is a process where a gold containing leach solution is exposed to a solid phase (e.g., carbon or resin). The solid phase extracts the gold (and silver) complex from the leach solution. This adsorption process is accomplished in a series of counter current stages as is well understood by those of ordinary skill in the art. The solid phase may be removed from the leach solution and washed, usually with an acidic solution. In a desorption process, the solid phase may be sent to a strip stage where the gold is eluted off of the solid phase with a strip aqueous solution. This strip solution can contain caustic (NaOH) and cyanide. This gold bearing strip solution may be sent for further processing, typically by electrowinning, to produce gold dore (Au/Ag product from the mine). In a regeneration process, the eluted solid phase optionally may be sent to further washing steps and/or to a regeneration operation, which can be completed in a high temperature kiln where the solid phase is fully “reactivated” and placed back into the adsorption process.

Extraction reagents as described herein preferably are compatible with the ADR system because the reagents will be in the leach solution and may be extracted by the solid phase or compete with gold adsorption onto the solid phase. According to embodiments, the reagents as described herein may be more compatible with SX/EW in copper processes than other known reagents, and therefore, also may be more compatible with this ADR process when compared to other known reagents.

According to embodiments, the leaching aid can be added to a lixiviant solution that is passed through an ore during an extraction process. The ore may be subjected to an agglomeration process prior to leaching with the lixiviant solution. In certain embodiments, the leaching aid can be added to water and the lixiviant (e.g., an alkaline cyanide) with no further addition of the leaching aid to the lixiviant solution circulated through the ore to leach the metal (e.g., gold). In yet further embodiments, the leaching aid can be added to a portion of the lixiviant solution with or without the addition of cement or polymer for use as an agglomeration aid followed by passing lixiviant through the ore with or without the leaching aid. When recovering gold in an ADR system, it is expected that the leaching aids (e.g., TMP-7(EO)) will not significantly compete with gold adsorption to carbon or resin, and will not be heavily removed from the system by the carbon or resin, when compared to typical leaching aids and surfactants.

### Example 1 (Prophetic)

Approximately 90 Kg of agglomerated ore is leached for 200 days in batches in polyvinyl chloride columns. During the column tests, leaching aid according to the disclosure herein is applied to the agglomerated ore at the following doses: 0 ppm, 25 ppm, 50 ppm and 75 ppm. A distribution felt is used to evenly dispense the alkaline cyanide lixiviant solution onto the ore. Each column has a high precision pump and lixiviant reservoir. Solution is collected from the bottom of the column into buckets which eventually are placed on analytical balances so that the amount of solution can be easily tracked. The leach rate is 5-10 L/hr/m\hat{ }2 of 0.1-0.2 g/L alkaline cyanide at 75° F. The lixiviant is added in a one pass system where there is no recirculation of the lixiviant (open cycle). Samples are collected daily for the 200 day leaching trial. For improved precision, the lixiviant solution can be recirculated (closed cycle), so the solution builds the concentration of leached gold and silver. In this case, lixiviant and caustic must be measured and maintained at minimum levels throughout the leaching trial. For each column, a sample is analyzed for pH, cyanide, gold concentration, and silver concentration. The lixiviant samples are also analyzed each day to ensure there is no contamination or change in concentration of chemical species. The solution feed rates are measured every day and if any adjustments are needed, the appropriate changes are made.

At the end of the testing period, the amount of gold leached is reported as a percentage and compared to the total amount gold in the ore that is cyanide soluble (i.e., using a bottle roll test). The percent of gold leached in excess of the control is graphed as a function of time to show the efficiency of the leaching aid.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A solution comprising:
a lixiviant for extracting gold; and
one or more compound comprising formula (I):
R((AO)ₙB)ₘ((AO)ₙH)ₚ (I)
wherein each AO group is, independently, an alkyleneoxy group selected from ethyleneoxy (“EO”), 1,2-propyleneoxy (“PO”), 1,2-butyleneoxy, and styryleneoxy;
each n is independently an integer from 0 to 40;
m is an integer from 1 to the total number of OH hydrogens in the R group prior to alkoxylation;
p is an integer such that the sum of m plus p equals the number of OH hydrogens in the R group prior to alkoxylation;
B is H;
R is a group selected from formula (II) to (VIII):

| | |
|---|---|
| R₁C(CH₂O)₃ | (II) wherein R₁ is H, methyl, ethyl, or propyl; |
| C(CH₂O)₄ | (III); |
| OC(CH₂O)₂ | (IV); |
| N(CH₂ CH₂O) | (V) |
| (R₂)ₓN(CH₂ CH₂O) | (VI) wherein R₂ is a C₁-C₄ alkyl, y is 1-3 and |
| | x + y = 3; |
| O(CH₂)ᵣO | (VII), wherein r is 2 to 6; and |
| O(CH(CH₃)CH₂)O | (VIII); |

wherein the one or more compound is at a concentration of about 1 ppm to about 500 ppm of the solution, and
optionally wherein the solution further comprises gold.

2. The solution of claim 1, wherein each n is independently 2 to 20.

3. The solution of claim 2, wherein each n is independently 2 to 10.

4. The solution of claim 1, comprising at least one compound having the following structure:

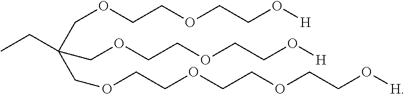

5. The solution of claim 1, wherein the lixiviant comprises sodium cyanide, a bromide ion, a chlorine ion, an iodide ion, thiosulfate or thiocyanide.

6. The solution of claim 1, wherein the lixiviant is at a concentration of about 1 mg/L to about 10 g/L of the solution.

7. The solution of claim 5, wherein the lixiviant is at a concentration of 1 mg/L to about 10 g/L of the solution.

8. The solution of claim 1, wherein the lixiviant is at a concentration of about 1 mg/L to about 1 g/L of the solution.

9. The solution of claim 7, wherein the lixiviant is at a concentration of about 1 mg/L to about 1 g/L of the solution.

10. The solution of claim 1, wherein the one or more compound is at a total concentration of about 5 ppm to about 100 ppm.

11. The solution of claim 4, wherein the one or more compound is at a total concentration of about 5 ppm to about 100 ppm.

12. The solution of claim 1, wherein the one or more compound is at a total concentration of about 15 ppm to about 30 ppm.

13. The solution of claim 4, wherein the one or more compound is at a total concentration of about 15 ppm to about 30 ppm.

14. The solution of claim 4, wherein the one or more compound is at a total concentration of at least about 25 ppm.

15. The solution of claim 1, further comprising an additional metal.

16. The solution of claim 15, wherein the additional metal is selected from a group consisting of copper, silver, nickel, zinc, molybdenum, vanadium, uranium, and combinations thereof.

17. A solution, comprising:
a lixiviant for extracting gold; and
one or more compound having formula (IX): 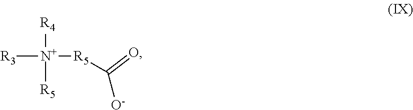
wherein R₃ is a C₁ to C₂₀ linear or branched alkyl group comprising zero or more substitutions with any of O, N, OH or 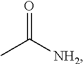
R₄ and R₆ are each, independently, H, a C₁ to C₁₀ linear or branched alkyl group or an alcohol group,
R₅ is a C₁ to C₁₀ linear or branched alkyl group; and
wherein the one or more compound is at a concentration of about 5 ppm to about 500 ppm,
wherein when the solution has a pH of less than 7.0, formula (IX) further comprises a counter ion to the O⁻ selected from a group consisting of H, a sulfate group and a sulfonate group, and
optionally wherein the solution further comprises gold.

18-36. (canceled)

37. A solution, comprising:
a lixiviant for extracting gold; and
at least one compound as recited in claim 1 and at least one compound as recited in claim 17.

38. (canceled)

39. A method of leaching gold from an ore, the method comprising: contacting the ore comprising the gold with the solution according to claim 1.

40. The method of claim 39, wherein the lixiviant comprises sodium cyanide, and wherein contacting the ore comprises pile leaching, tray leaching or vat leaching to form a cyanized leached ore.

41-43. (canceled)

44. A method of recovering gold from an ore, comprising:
contacting the ore comprising the gold with the solution according to claim 1, to form a pregnant leaching solution; and
recovering the gold from the pregnant leaching solution.

46-49. (canceled)

50. A solution comprising:
a lixiviant comprising an alkaline cyanide; and
a mixture of compounds formed by alkoxylation of trimethylolpropane (“TMP”), wherein each of the compounds comprises ethylene oxide (“EO”) units, the compounds having the general structure:
TMP-EO_{x,y,z}, where x, y and z are independently an integer from 0 to 7, with the proviso that x+y+z=0 to 21,
wherein the mixture is at a total concentration of about 1 ppm to about 100 ppm, and
optionally wherein the solution comprises gold.

51-63. (canceled)

64. The solution of claim 1, wherein the lixiviant does not comprise sulfuric acid.

65. (canceled)
